(19) United States
(12) Patent Application Publication
(10) Pub. No.: US 2023/0141694 A1
(43) Pub. Date: May 11, 2023

(54) BRAKE APPARATUS FOR VEHICLE

(71) Applicant: HYUNDAI MOBIS CO., LTD., Seoul (KR)

(72) Inventors: Sung Ki AHN, Yongin-si (KR); Seung Hwan JEONG, Seoul (KR)

(73) Assignee: HYUNDAI MOBIS CO., LTD., Seoul (KR)

(21) Appl. No.: 17/941,069

(22) Filed: Sep. 9, 2022

(30) Foreign Application Priority Data
Nov. 5, 2021 (KR) 10-2021-0151791

(51) Int. Cl. B60T 13/68; B60T 15/02; B60T 13/14; B60T 13/58; B60T 13/74

(52) U.S. Cl. CPC B60T 13/686; B60T 15/028; B60T 13/147; B60T 13/148; B60T 13/588; B60T 13/74; B60T 2270/306

(57) ABSTRACT

According to at least one embodiment, the present disclosure provides a brake system for a vehicle which includes a 3-way solenoid valve to reduce the number of solenoid valves mounted to the brake system.

### CROSS-REFERENCE TO RELATED APPLICATIONS

This application claims the benefit of priority to Korean Patent Application Number 10-2021-0151791, filed on Nov. 5, 2021, the disclosure of which is incorporated herein by reference in its entirety.

### TECHNICAL FIELD

The present disclosure relates to a brake system for a vehicle.

### BACKGROUND

The contents described in this section simply provide background information related to the present disclosure and do not constitute the prior art.

A hydraulic brake system of a vehicle selectively transfers working fluid to a plurality of wheel brake mechanisms by adjusting the opening/closing state of a plurality of solenoid valves.

FIG. 11 is a block diagram schematically illustrating a hydraulic circuit of a conventional brake system for a vehicle. Referring to FIG. 11, in the case that an inlet valve 1 is opened and an outlet valve 2 is closed, a fluid in a fluid storage unit 5 may be pressurized by a master cylinder 8 and transferred to a wheel brake 7. This increases braking pressure of the wheel brake 7. In the case that the inlet valve 1 is closed and the outlet valve 2 is opened, the fluid inside the wheel brake 7 is transferred to the fluid storage unit 5 and the braking pressure of the wheel brake 7 decreases. The conventional brake system for the vehicle includes both the inlet valve 1 and the outlet valve to adjust the braking pressure applied to the vehicle.

Meanwhile, in the case that a traction control valve 3 is opened, the fluid pressurized by the master cylinder 8 may be transferred to the wheel brake 7. In the case that a high-pressure switch valve 4 is opened, fluid may be supplied from the fluid storage unit 5 to a pump. The pump assists the master cylinder 8 to generate hydraulic pressure corresponding to the required braking force. The brake system for the vehicle may include both the traction control valve 3 and the master cylinder 8 to control the flow of fluid flowing out from or flowing in the master cylinder 8 or the pump.

Such a vehicle brake system includes a plurality of solenoid valves, which results in the high manufacturing cost and the large volume.

### SUMMARY

According to at least one embodiment, the present disclosure provides a brake system for a vehicle, comprising: a fluid storage unit; a fluid pressing unit; a plurality of wheel brakes configured to apply braking force to the vehicle using internal hydraulic pressure; and at least one 3-way solenoid valve configured to selectively connect the fluid storage unit, the fluid pressing unit, and the wheel brakes, wherein the 3-way solenoid valves comprises: first to third ports; an armature to which electromagnetic force is applied; a first body having one side disposed to face the armature and having a hollow therein; a second body having one side disposed to face the first body and having a hollow therein; a plunger configured such that at least a portion thereof penetrates the hollow in the first body and the second body, and one end thereof is pressed and moved by the armature; a first opening/closing flow passage configured to fluid-communicate with or block the first port and the second port; and a second opening/closing flow passage configured to fluid-communicate with or block the second port and the third port.

### BRIEF DESCRIPTION OF THE DRAWINGS

FIG. 1 is a hydraulic circuit diagram illustrating a brake system for a vehicle according to a first embodiment of the present disclosure.

FIG. 2 is a hydraulic circuit diagram illustrating a brake system for a vehicle according to a second embodiment of the present disclosure.

FIG. 3 is a cross-sectional view of a 3-way solenoid valve of the brake system according to the first embodiment of the present disclosure.

FIG. 4 is a cross-sectional view illustrating an integrated valve on a wheel side of the brake system according to the second embodiment of the present disclosure.

FIG. 5 is a cross-sectional view illustrating an integrated valve on a pressing unit side of the brake system according to the second embodiment of the present disclosure.

FIG. 6 is a hydraulic circuit diagram illustrating a flow path of a fluid in the case that braking pressure of the brake system according to the first embodiment of the present disclosure is increased.

FIG. 7 is a hydraulic circuit diagram illustrating a flow path of the fluid in the case that braking pressure of the brake system according to the first embodiment of the present disclosure is decreased.

FIG. 8 is a hydraulic circuit diagram illustrating a flow path of the fluid in the case that hydraulic pressure is selectively supplied to some of wheel brakes according to the first embodiment of the present disclosure.

FIG. 9 is a hydraulic circuit diagram illustrating a flow path of the fluid in the case that a second pump of the brake system according to the first embodiment of the present disclosure is driven.

FIG. 10 is a hydraulic circuit diagram illustrating a flow path of the fluid in the case that a pump of the brake system according to the second embodiment of the present disclosure is driven.

FIG. 11 is a block diagram schematically illustrating a hydraulic circuit of a conventional brake system for a vehicle.

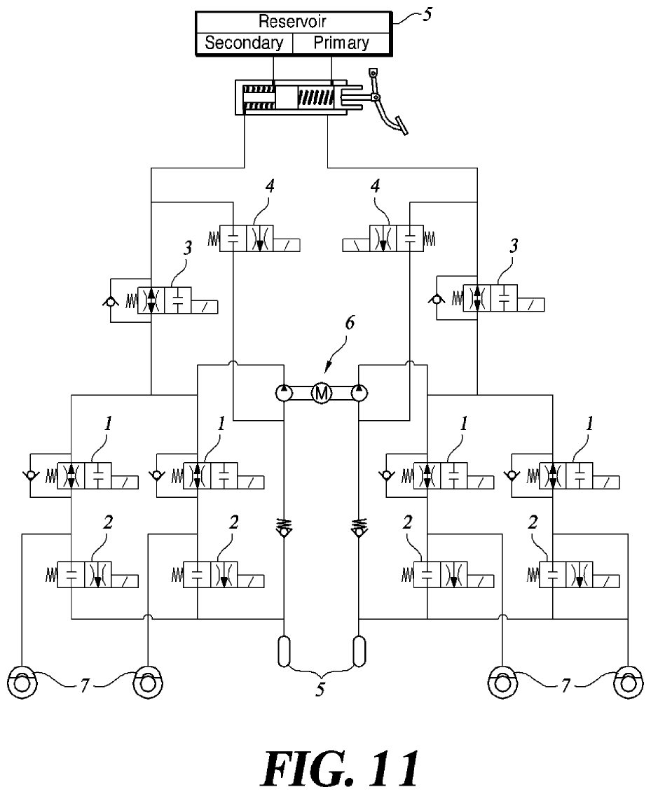

### DETAILED DESCRIPTION

In view of the above, the present disclosure provides a brake system for a vehicle which includes a 3-way solenoid valve to reduce the number of solenoid valves mounted to the brake system.

The objects to be achieved by the present disclosure are not limited to the above-mentioned objects, and other objects not mentioned may be clearly understood by those skilled in the art from the following description.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, alphanumeric codes such as first, second, i), ii), (a), (b), etc., in numbering components are used solely for the purpose of differentiating one component from the other but not to imply or suggest the substances, the order, or sequence of the components. Throughout this specification, when parts “include” or “comprise” a component, they are meant to further include other components, not excluding thereof unless there is a particular description contrary thereto. The terms such as ‘unit,’ ‘module,’ and the like refer to one or more units for processing at least one function or operation, which may be implemented by hardware, software, or a combination thereof.

In the present disclosure, the connection of the components means that the components are fluidly connected.

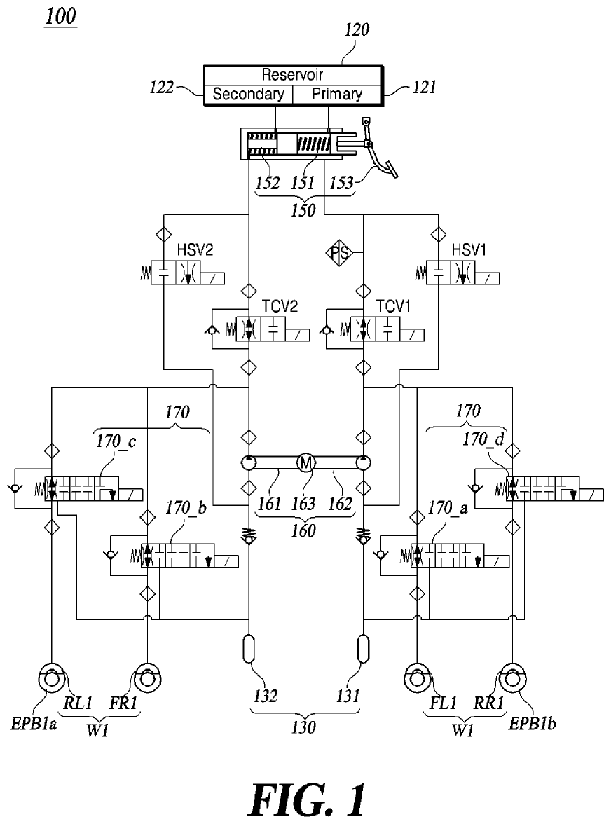

FIG. 1 is a hydraulic circuit diagram illustrating a brake system for a vehicle according to a first embodiment of the present disclosure.

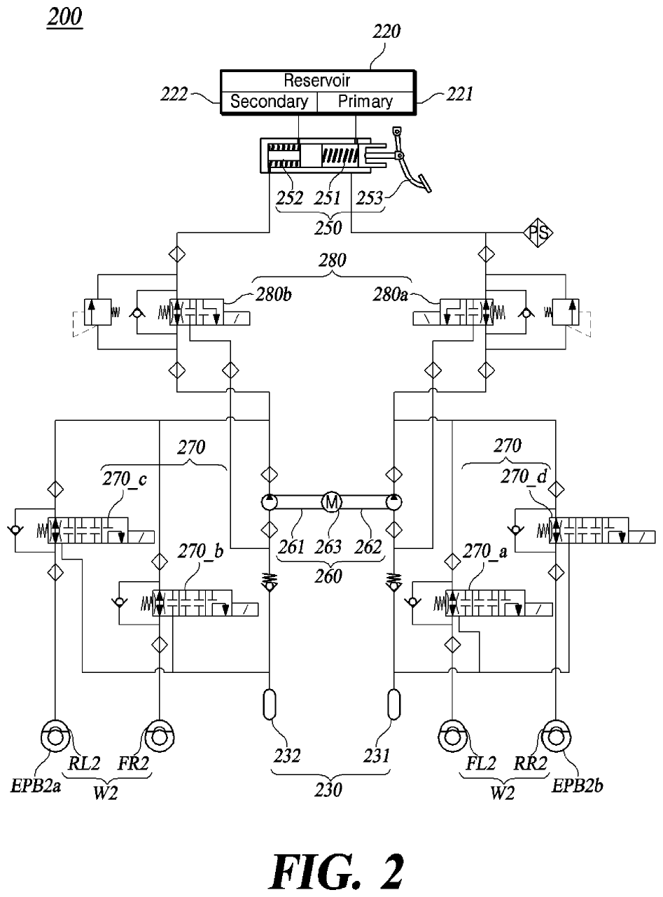

FIG. 2 is a hydraulic circuit diagram illustrating a brake system for a vehicle according to a second embodiment of the present disclosure.

Referring to FIGS. 1 and 2, a brake system for a vehicle 100 or 200 according to the first or second embodiment of the present disclosure includes all or part of fluid storage units 120 and 130, or 220 and 230, fluid pressing units 150 and 160, or 250 and 260, wheel brakes w1 or w2, 3-way solenoid valves 170, or 270 and 280, traction control valves TCV1 and TCV2, high pressure switch valves HSV1 and HSV2 and electronic parking brakes EPB1a and EPB1b, or EPB2a and EPB2b.

The wheel brakes w1 and w2 are configured to apply a braking force to the vehicle using an internal hydraulic pressure. The wheel brakes w1 and w2 may be caliper brakes or drum brakes. The wheel brakes w1 or w2 of the brake system 100 or 200 may include a front left wheel brake FL1 or FL2, a front right wheel brake FR1 or FR2, a rear left wheel brake RL1 or RL2, and a rear right wheel brake RR1 or RR2. Each of the wheel brakes w1 or w2 may be connected to the fluid storages units 120 and 130 or 220 and 230, and the fluid pressing units 150 and 160 or 250 and 260 with the 3-way solenoid valves 170 or 270 and 280 interposed therebetween. In the case that the fluid pressurized by the fluid pressing units 150 and 160 or 250 and 260 is transferred to the wheel brakes w1 or w2, the hydraulic pressure inside the wheel brakes w1 or w2) increases. Accordingly, the braking pressure applied to the wheels by the wheel brakes w1 or w2 increases. In the case that the fluid inside the wheel brakes w1 or w2 is transferred to the fluid storages units 120 and 130 or 220 and 230, the hydraulic pressure inside the wheel brakes w1 or w2 decreases. As a result, the braking pressure applied to the wheels by the wheel brakes w1 or w2 is reduced. In the case that the hydraulic pressure inside the wheel brakes w1 or w2 is maintained, the braking pressure is maintained.

The fluid storage units 120 and 130 or 220 and 230 are configured to store fluid. Fluid on the sides of the fluid storage units 120 and 130 or 220 and 230 may be supplied to the fluid pressing units 150 and 160 or 250 and 260. The fluid storage units 120 and 130 or 220 and 230 may include an oil reservoir 120 or 220 and/or accumulator 130 or 230.

The fluid inside the oil reservoir 120 or 220 may be transferred to the wheel brakes w1 or w2 through the fluid pressing units 150 and 160 or 250 and 260. The inlets of pumps 160 or 260 and the wheel brakes w1 or w2 may be connected in parallel to the oil reservoir 120 or 220. A master cylinder 150 or 250 may be connected in series between the oil reservoir 120 or 220 and the wheel brakes w1 or w2. The oil reservoir 120 or 220 may include a first reservoir chamber 121 or 221 and a second reservoir chamber 122 or 222. A first hydraulic chamber 151 or 251 may be connected in series between the first reservoir chamber 121 or 221 and the wheel brakes (w1 or w2), and a second hydraulic chamber 152 or 252 may be connected in series between the second reservoir chamber 122 or 222 and the wheel brakes w1 or w2. Fluid on the side of the first reservoir chamber 121 or 221 may be supplied to a first pump 161 or 261 through the first hydraulic chamber 151 or 251. The fluid on the side of the second reservoir chamber 122 or 222 may be supplied to a second pump 162 or 262 through the second hydraulic chamber 152 or 252.

The accumulators 130 or 230 are configured to receive fluid from the wheel brakes w1 or w2) in the case that the braking pressure is reduced. The brake system 100 or 200 may include a first accumulator 131 or 231 and a second accumulator 132 or 232. The first accumulator 131 or 231 may be connected to the first pump 161 or 261, the front left wheel brakes FL1 or FL2, and the rear right wheel brakes RR1 or RR2, and the second accumulator 132 or 232 may be connected to the second pump 162 or 262, the right front wheel brakes RR1 or RRL2 and the rear left wheel brake RL1 or RL2. The accumulators 130 or 230 are connected to the inlets of the pumps 160 or 260, and the fluid transferred from the accumulators 130 or 230 to the pumps 160 or 260 may be pressurized in the pumps 160 or 260.

The fluid pressing units 150 and 160 or 250 and 260 are configured to press the fluid. The fluid pressing units 150 and 160 or 250 and 260 are configured to form hydraulic pressure corresponding to a braking signal. Here, the braking signal may be a signal corresponding to an input amount of pedals 153 or 253 by a driver or a deceleration signal provided by an autonomous driving system. The fluid pressing units 150 and 160 or 250 and 260 may include all or part of a master cylinder 150 or 250 and pumps 160 or 260. The master cylinder 150 or 250 may include a pedal 153 or 253, a first hydraulic chamber 151 or 251, and a second hydraulic chamber 152 or 252. The front left wheel brake FL1 or FL2 and the rear right wheel brake RR1 or RR2 are connected in parallel to the first hydraulic chamber 151 or 251, and fluid pressurized by the first hydraulic chamber 151 or 251 may be transferred to the front left wheel brake FL1 or FL2 and the rear right wheel brake RR1 or RR2. The front right wheel brake FR1 or FR2 and the rear left wheel brake RL1 or RL2 are connected in parallel to the second hydraulic chamber 152 or 252, and fluid pressurized by the second hydraulic chamber 152 or 252 may be transferred to the front right wheel brake FR1 or FR2 and the rear left wheel brake RL1 or RL2. However, the present disclosure is not limited to such a connection relationship. For example, the brake systems 100 or 200 according to one embodiment of the present disclosure may be configured such that each of the wheel brakes w1 or w2 receives all of the fluid pressurized by the first hydraulic chamber 151 or 251 and the second hydraulic chamber 152 or 252.

The pumps 160 or 260 may be configured to assist the master cylinder 150 or 250 and to generate braking hydraulic pressure in the case that the braking hydraulic pressure formed in the master cylinder 150 or 250 is not sufficient to form the required braking force. In the brake system 100 or 200 of an autonomous vehicle, the master cylinder 150 or 250 that receives pedal pressure of a driver is not mounted, and only the pumps 160 or 260 may be mounted. The pumps 160 or 260 may generate hydraulic pressure corresponding to a deceleration signal provided by the autonomous driving system. The brake systems 100 or 200 may include the first pump 161 or 261 and the second pump 162 or 262. The front left wheel brake FL1 or FL2 and the rear right wheel brake RR1 or RR2 are connected in parallel to the first pump 161 or 261, and fluid pressurized by the first pump 161 or 261 may be transferred to the front left wheel brake FL1 or FL2 and the rear right wheel brake RR1 or RR2. The front right wheel brake FR1 or FR2 and the rear left wheel brake RL1 or RL2 are connected in parallel to the second pump 162 or 262, and fluid pressurized by the second pump 162 or 262 may be transferred to the front right wheel brake FR1 or FR2 and the rear left wheel brake RL1 or RL2. However, the present disclosure is not limited to such a connection relationship. For example, the brake system 100 or 200 according to one embodiment of the present disclosure may be configured such that each of the wheel brakes w1 or w2 receives all of the fluid pressurized from the first pump 161 or 261 and the second pump 162 or 262. The pumps 160 or 260 of the present disclosure may be a motor pump configured to be pressed in a radial direction by an eccentric shaft (not shown) of a motor 163 or 263, or may be a gear pump including a driving gear (not shown) that rotates in combination with a rotation shaft of the motor 163 or 263 and a driven gear (not shown) that rotates in engagement with the driving gear.

The brake system 100 or 200 includes all or part of three-way solenoid valves 170 or 270 and 280, traction control valves TCV1 and TCV2), and a high-pressure switch valves HSV1 and HSV2. The 3-way solenoid valves 170 or 270 and 280, the traction control valves TCV1 and TCV2, and the high-pressure switch valves HSV1 and HSV2 are configured to change a path through which fluid flows and/or the amount of fluid flowing in the flow path in the brake system 100 or 200 in response to a valve control signal. The 3-way solenoid valves 170 or 270 and 280, the traction control valves TCV1 and TCV2, and the high-pressure switch valves HSV1 and HSV2 may be configured to change their opening and closing states depending on the magnitude of current applied thereto.

Referring to FIG. 1, in the brake system for a vehicle according to the first embodiment of the present disclosure, traction the control valves TCV1 and TCV2 are installed on flow paths connecting the master cylinder 150 and the wheel brakes w1. The first traction control valve TCV1 may be connected to the first hydraulic chamber 151, the front left wheel brake FL1 and the rear right wheel brake RR1, and the second traction control valve TCV2 may be connected to the second hydraulic chamber 152, the front right wheel brake FR1, and the rear left wheel brake RL1. The traction control valves TCV1 and TCV2 regulate the flow of fluid transmitted from the master cylinder 150 to the wheel brakes w1. The traction control valves TCV1 and TCV2 may be a normal open type valve which opens the flow path when no current is applied to a coil (not illustrated). High pressure switch valves HSV1 and HSV2 are installed in flow paths connecting the fluid storage units 120 and 130 and the inlets of the pumps 160, respectively. The high-pressure switch valves HSV1 and HSV2 may be installed in the flow paths connecting the inlets of the pumps 160 and the oil reservoir 120, respectively. A first high pressure switch valve HSV1 may be connected to the first hydraulic chamber 151 and the first pump 161, and a second high pressure switch valve HSV2 may be connected to the second hydraulic chamber 152 and the second pump 162. The high-pressure switch valves HSV1 and HSV2 regulate the flow of fluid transferred from the fluid storage units 120 and 130 to the inlets of the pumps 160. The high-pressure switch valves HSV1 and HSV2 may be a normal close type valve that closes the flow path when no current is applied to a coil.

Referring to FIG. 1 or 2, the electronic parking brakes EPB1a and EPB1b or EPB2a and EPB2b may be mounted on the rear wheels. The electronic parking brakes are configured to generate a braking force to assist the wheel brakes of the present disclosure.

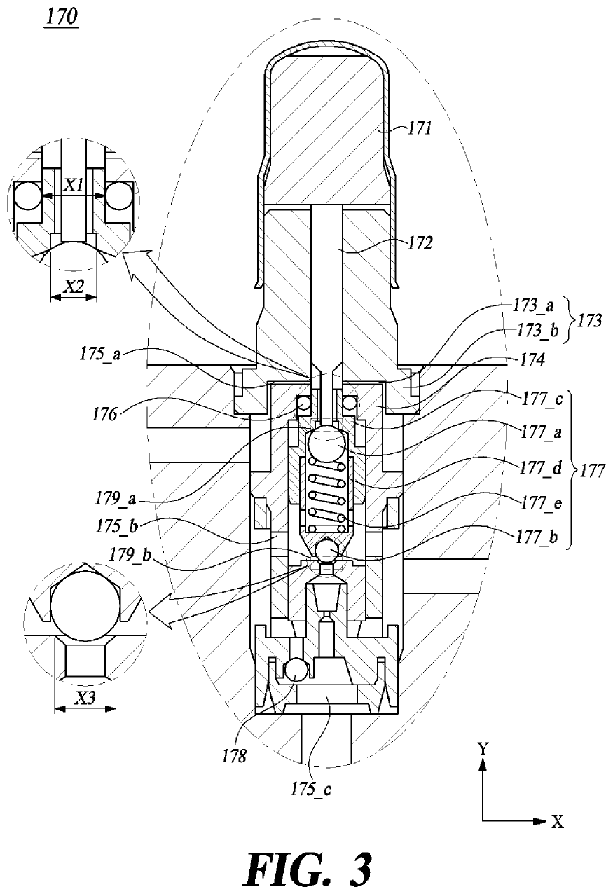

FIG. 3 is a cross-sectional view of the 3-way solenoid valve of the brake system for a vehicle according to the first embodiment of the present disclosure. In the present disclosure, a longitudinal direction of the 3-way solenoid valve 170 is referred to as a Y-axis direction. Among the directions illustrated in the drawings, an upward direction is referred to as a ‘positive Y direction’ and a downward direction is referred to as a ‘negative Y direction’.

Referring to FIG. 3, the 3-way solenoid valve 170 according to the first embodiment of the present disclosure includes all or part of first to third ports 175_a to 175_c, first and second opening/closing flow passages 179_a and 179_b, first and second bodies 173 and 174, a coil (not shown), an armature 171, a plunger 172, a sealing member 176, first and second fluid control units 177_a and 177_b, an elastic member 177_e, and a check valve 178.

The armature 171 is configured to form an electromagnetic force corresponding to the magnitude of a current applied to the coil. The coil may be disposed to surround an outer peripheral surface of the armature 171. The electromagnetic force formed by the armature 171 acts on the armature 171 to move the armature 171 toward the first body 173. As the electromagnetic force formed on the armature 171 increases, the armature 171 and the first body 173_b ecome closer to each other. Hereinafter, the electromagnetic force formed by the armature 171 is simply referred to as an ‘electromagnetic force.

The first body 173 is disposed such that one side thereof faces the armature 171 and has a hollow (i.e., first hollow) therein. The second body 174 is disposed such that one side thereof faces the other side of the first body 173 and has a hollow (i.e., second hollow) therein. The plunger 172 slides in the hollows of the first and second bodies 173 and 174 and may linearly move in the Y-axis direction. A groove disposed or formed at a lower end of the first body 173 and an upper surface of the second body 174 may form an outer peripheral surface of the flow path configured to connect the first port 175_a, the second port 175_b, or the third port 175_c to the hollow inside the second body 174. On the other hand, a groove disposed or formed at an upper end of the second body 174 and a lower surface of the second body 174 may be configured to connect the first port 175_a, the second port 175_b, or the third port 175_c to the hollow inside the second body 174. A concave groove portion 173_a is formed on the lower surface of the first body 173, and at least a portion of the second body 174 is accommodated in the groove portion 173_a. The 3-way solenoid valve 170 configured in this way has a shorter length and a simpler shape than a conventional 3-way solenoid valve, so that the volume of the brake system can be reduced and the manufacturing cost thereof can be lowered. A flange portion 173_b is formed at the lower end of the first body 173.

At least a portion of the plunger 172 is configured to penetrate the hollow inside the first body 173 and the hollow inside the second body 174. One end surface of the plunger 172 faces the armature 171. The plunger 172 and the armature 171 have cylindrical shapes having the same center line, and the plunger 172 may be disposed to contact a lower end surface of the armature 171. The other end surface of the plunger 172 faces a flow path control assembly 177. The flow path control assembly 177 may include the first fluid control unit 177_a that opens and closes the first opening/closing flow passage 179_a, and may be disposed such that the lower end surface of the plunger 172 faces the first fluid control unit 177_a. The plunger 172 is configured to move by the armature 171 pressing one end of the plunger 172. The armature 171 moves toward the first body 173_b y electromagnetic force to press the plunger 172 in the negative Y direction. In the case that the plunger 172 is pressed in the negative Y direction, the first fluid control unit 177_a is pressed in the negative Y direction. Hereinafter, a force of the plunger 172 pressing the first fluid control unit 177_a is referred to as a pressing force.

The lower end of the plunger 172 may be disposed to penetrate a portion of the flow path control assembly 177. The elastic member 177_e is disposed inside the flow path control assembly 177. Due to this arrangement, when the armature 171 presses the plunger 172, the plunger 172 may press the elastic member 177_e. The plunger 172 applies a pressing force corresponding to the electromagnetic force formed by the armature 171 to the elastic member 177_e. A cross-sectional area of a lower portion of the plunger 172 may be smaller than a cross-sectional area of an upper portion of the plunger 172 to penetrate a portion of the flow path control assembly 177. Here, the cross-sectional area refers to a cross-sectional area in a plane perpendicular to the Y-axis.

The sealing member 176 is disposed between the flow path control assembly 177 and the second body 174. The sealing member 176 is in close contact with an outer peripheral surface of an upper housing 177_c and an inner peripheral surface of the second body 174 to prevent the fluid from flowing between the flow path control assembly 177 and the second body 174. The fluid may move only through a space within the flow path control assembly 177.

The flow path control assembly 177 is disposed inside the second body 174. The flow path control assembly 177 includes all or part of a first fluid control unit 177_a, housings 177_c and 177_d, an elastic member 177_e, and a second fluid control unit 177_b.

The first fluid control unit 177_a is configured to open or close the first opening/closing flow passage 179_a depending on the magnitude of the pressing force. The first fluid control unit 177_a is disposed in contact with the lower end of the plunger 172 and the upper end of the elastic member 177_e in the flow path control assembly 177. When the plunger 172 is pressed by the armature 171, the first fluid control unit 177_a in contact with the lower end of the plunger 172 is pressed in the negative Y direction by the plunger 172. When the plunger 172 presses the first fluid control unit 177_a with a sufficient force, the first fluid control unit 177_a moves toward the elastic member 177_e to open the first opening/closing flow passage 179_a. As shown in FIG. 3, the first fluid control unit 177_a may be formed in a sphere shape, but is not limited thereto and may be formed in any shape which is able to be disposed in the housings 177_c and 177_d and close the first opening/closing flow passage 179_a.

The housings 177_c and 177_d are configured to move linearly in the Y-axis direction in the first and second bodies 173 and 174. Fluid outside the housings 177_c and 177_d may be introduced into the housings 177_c and 177_d through orifices formed in the housings 177_c and 177_d. An opening is formed in an upper portion of the housings 177_c and 177_d such that a portion of the plunger 172 may penetrate therethrough. The housings 177_c and 177_d may include an upper housing 177_c and a lower housing 177_d as illustrated in FIG. 3, but may be integrally formed.

The elastic member 177_e may be disposed inside the housings 177_c and 177_d, and may be disposed such that one end thereof contacts the first fluid control unit 177_a and the other end thereof contacts a lower surface of the housings 177_c and 177_d. The elastic member 177_e may provide an elastic force to the first fluid control unit 177_a and the lower housing 177_d. The magnitude of the elastic force of the elastic portion 177_e corresponds to the magnitude of the pressing force. When the elastic member 177_e is pressed in the negative Y direction by the first fluid control unit 177_a, the housings 177_c and 177_d are pressed in the negative Y direction.

The second fluid control unit 177_b may be disposed at an outer lower end of the housings 177_c and 177_d. The second opening/closing flow passage 179_b is opened or closed as the second fluid control unit 177_b moves in the Y-axis direction from an upper end of the second opening/closing flow passage 179_b.

The 3-way solenoid valve 170 may include a check valve 178 that allows fluid to flow only in one direction. Specifically, the check valve 178 allows the fluid to flow from the second port 175_b to the third port 175_c only. The check valve 178 may be disposed below the 3-way solenoid valve 170. The check valve 178 is formed such that the fluid flows only in the direction from the second port 175_b to the third port 175_c, which replaces the role of a check valve disposed in a conventional inlet valve.

The first port 175_a and the second port 175_b may be formed on a side surface of the 3-way solenoid valve 170. The third port 175_c may be formed in a lower portion of the 3-way solenoid valve 170. However, the first to third ports 175_a to 175_c of the present disclosure are not limited to the above-described configuration and connection relationship. A fluid introduced into a portion of the first to third ports 175_a to 175_c may flow through the valve chamber D to another portion of the first to third ports 175_a to 175_c.

In at least a part of the 3-way solenoid valves 170 according to the first embodiment of the present disclosure, the first port 175_a is connected to the fluid storage units 120 and 130, the second port 175_b is connected to the wheel brakes w1, and the third port 175_c is connected to the outlets of the fluid pressing units 150 and 160. Referring to FIG. 1, in at least a part of the 3-way solenoid valves 170 according to the first embodiment, the first port 175_a may be connected to the accumulator 130, the second port 175_b may be connected to the wheel brakes w1, and the third port 175_c may be connected to the outlets of the pumps 160. In the present disclosure, the 3-way solenoid valve 170 connected in this way is referred to as a wheel-side integrated valve 170. The brake system 100 may include a front left wheel-side integrated valve 170_a, a front right wheel-side integrated valve 170_b, a rear left wheel-side integrated valve 170_c, and a rear right wheel-side integrated valve 170_d. The front left and rear right wheel-side integrated valves 170_a and 170_d may be connected to the first accumulator 131, the first pump 161, and the first hydraulic chamber 151, and the front right and rear left wheel-side integrated valves 170_b and 170_c may be connected to the second accumulator 132, the second pump 162, and the second hydraulic chamber 152. Each wheel-side integrated valve 170 functions as both an inlet valve and an outlet valve.

The magnitude of the electromagnetic force may be adjusted by adjusting the magnitude of a current applied to the 3-way solenoid valve 170. By adjusting the magnitude of the electromagnetic force, opening and closing of the first opening/closing flow passage 179_a and the second opening/closing flow passage 179_b may be adjusted. Here, the first to third electromagnetic forces are preset values, which may be experimentally obtained and stored in a memory of a controller in the form of a look-up table (LUT). Each of the first to third electromagnetic forces may be a value determined within a predetermined range. The second electromagnetic force is greater than the first electromagnetic force, and the third electromagnetic force is greater than the second electromagnetic force.

In the case that no current is applied to the 3-way solenoid valve 170, no electromagnetic force is applied to the armature 171. When no electromagnetic force is applied to the armature 171, the armature 171 does not press the plunger 172. The second opening/closing flow passage 179_b can be opened and closed due to a pressure difference between the second and third ports 175_b and 175_c and the first port 175_a. Specifically, when no electromagnetic force is applied to the armature 171, the armature 171 does not move toward the first body 173. Accordingly, the plunger 172 does not press the flow path control assembly 177. In this case, the first fluid control unit 177_a is pressed upward by the elastic force of the elastic member 177_e to close the first opening/closing flow passage 179_a.

The fluid introduced into the second port 175_b and the third port 175_c presses a first area X1 in the positive Y direction, and the second opening/closing flow passage 179_b is opened. The fluid pressurized in the fluid pressing units 150 and 160 sequentially passes through the second opening/closing flow passage 179_b and the second port 175_b to be transferred to the wheel brakes w1. When the pressure of the fluid pressing units 150 and 160 is released, the second opening/closing flow passage 179_b is opened to allow the fluid to flow from the second port 175_b to the third port 175_c so that the pressure of the wheel brakes w1 is decreased. When the fluid flows from the second port 175_b toward the third port 175_c, the fluid may also flow through the check valve 178. As a result, in the case that no current is applied to the coil, the 3-way solenoid valve 170 opens the second opening/closing flow passage 179_b between the second port 175_b and the third port 175_c, and closes the first opening/closing flow passage 179_a between the first port 175_a and the second port 175_b.

When the first opening/closing flow passage 179_a of the wheel-side integrated valve 170 is closed and the second opening/closing flow passage 179_b is opened, hydraulic pressure formed in the fluid pressing units 150 and 160 is transmitted to the wheel brakes w1, and the fluid in the wheel brakes w1 is not transferred to the accumulator 130. Such a fluid flow path corresponds to a fluid flow path in the case that the inlet valve is opened and the outlet valve is closed in the conventional brake system for a vehicle.

When a second current corresponding to the second electromagnetic force is applied to the 3-way solenoid valve 170, the second electromagnetic force is applied to the armature 171. The second electromagnetic force is greater than the sum of the force applied by the fluid introduced through the third port 175_c to the flow path control assembly 177 and the force applied by the fluid introduced through the second port 175_b to the flow path control assembly 177. Here, the force applied by the fluid introduced through the third port 175_c to the flow path control assembly 177 is caused by the pressure applied by the fluid introduced through the third port 175_c to a third area. The force applied by the fluid introduced through the second port 175_b to the flow path control assembly 177 is caused by the pressure applied by the fluid introduced through the second port 175_b to the first area X1 and the pressure applied to the third area X3. In addition, the second electromagnetic force is smaller than the sum of the force applied by the fluid introduced through the second port 175_b to a second area X2 and the elastic force of the elastic member 177_e.

The armature 171 to which the second electromagnetic force is applied indirectly presses the second fluid control unit 177_b to close the second opening/closing flow passage 179_b. The force of the armature 171 with the second electromagnetic force pressing the elastic member 177_e is not large enough to deform the elastic member 177_e, and thus the first opening/closing flow passage 179_a is also closed. Here, the indirect pressing of the armature 171 means that the plunger 172 moves in the negative Y direction due to the electromagnetic force of the armature 171, and the plunger 172 presses the flow path control assembly 177. When the second electromagnetic force is applied to the armature 171, a gap between the armature 171 and the first body 173 decreases. In the case that the second electromagnetic force is formed in the armature 171, all of the first and second opening/closing flow passages 179_a and 179_b are closed.

When all of the first and second opening/closing flow passages 179_a and 179_b of the wheel-side integrated valve 170 are closed, the hydraulic pressure formed in the fluid pressing units 150 and 160 is not transmitted to the wheel brakes w1. The fluid of the wheel brakes w1 is not transferred to the accumulator 130. As a result, the hydraulic pressure in the wheel brakes w1 is maintained. Such a fluid flow path corresponds to a fluid flow path in the case that both the inlet valve and the outlet valve are closed in the conventional brake system for a vehicle.

When a third current corresponding to the third electromagnetic force is applied to the 3-way solenoid valve 170, the third electromagnetic force corresponding to the third current is applied to the armature 171, and the armature 171 presses the plunger 172. The third electromagnetic force is set to be greater than the sum of the force applied by the fluid introduced through the second port 175_b to the second part X2 and the elastic force of the elastic member 177_e. The armature 171 to which the third electromagnetic force is applied indirectly presses the second fluid control unit 177_b to close the second opening/closing flow passage 179_b. In addition, the armature 171 indirectly presses the elastic member 177_e to be compressed. As the elastic member 177_e is compressed, the first opening/closing flow passage 179_a is opened. As a result, in the case that the third electromagnetic force is applied to the armature 171, the first opening/closing flow passage 179_a is opened and the second opening/closing flow passage 179_b is closed.

When the first opening/closing flow passage 179_a of the wheel-side integrated valve 170 is opened and the second opening/closing flow passage 179_b is closed, hydraulic pressure formed in the fluid pressing units 150 and 160 is not transmitted to the wheel brakes w1, and the fluid in the wheel brakes w1 sequentially passes through the second port 175_b and the second port 175_a to be transferred to the accumulator 130. As a result, the hydraulic pressure in the wheel brakes w1 is decreased. Such a fluid flow path corresponds to a fluid flow path in the case that the inlet valve is closed and the outlet valve is opened in the conventional brake system for a vehicle.

When a first current corresponding to the first electromagnetic force is applied to the 3-way solenoid valve 170, the first electromagnetic force is applied to the armature 171, and the armature 171 presses the plunger 172 to close the first opening/closing flow passage 179_a. The force of the armature 171 indirectly pressing the second fluid control unit 177_b is smaller than the force applied by the fluid introduced through the third port 175_c to the second fluid control unit 177_b. When the first electromagnetic force is applied to the armature 171, the second opening/closing flow passage 179_b is partially opened.

When the first opening/closing flow passage 179_a of the wheel-side integrated valve 170 is closed and the second opening/closing flow passage 179_b is completely opened, the pressure of the wheel brakes w1 may increase sharply to cause wheel-slip or wheel-lock. In order to prevent wheel slip or wheel lock, the first electromagnetic force corresponding to a force immediately before the first opening/closing flow passage 179_a is opened is formed in the armature 171, and then the first electromagnetic force is linearly reduced to partially open the second opening/closing flow passage 179_b.

When the first opening/closing flow passage 179_a of the wheel-side integrated valve 170 is closed and the second opening/closing flow passage 179_b is partially opened, the fluid pressurized by the fluid pressing units 150 and 160 passes sequentially through the third port 175_c and the second port 175_b to be transferred to the wheel brakes w1. Since the first opening/closing flow passage 179_a is closed, hydraulic pressure inside the wheel brakes w1 is not transmitted to the accumulator 130. As a result, the hydraulic pressure inside the wheel brakes w1 increases. Such a fluid flow path corresponds to a fluid flow path in the case that the inlet valve is partially opened and the outlet valve is closed in the conventional brake system for a vehicle.

The 3-way solenoid valve 170 may be configured to change the amount of fluid flowing between the first to third ports 175_a to 175_c as the current applied to the coil continuously changed. The opening and closing states of the plurality of solenoid valves included in the brake system 100 may be controlled independently of each other.

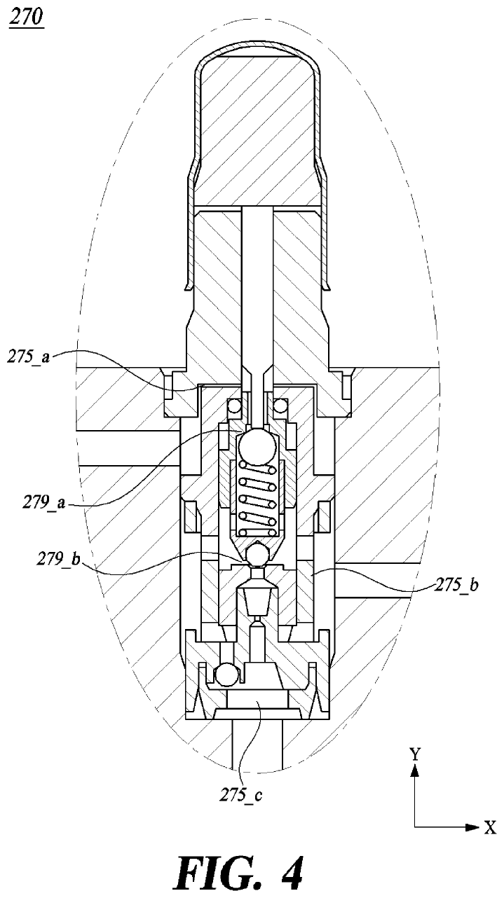

FIG. 4 is a cross-sectional view illustrating an integrated valve on the wheel side of the brake system for a vehicle according to a second embodiment of the present disclosure.

Referring to FIG. 4, a first port 275_a of some of the 3-way solenoid valves according to the second embodiment of the present disclosure is connected to the fluid storage units, a second port 275_b is connected to the wheel brakes w2, and a third port 275_c is connected to the outlets of the fluid pressing units 250 and 260. Referring to FIGS. 2 and 4, the first port 275_a of some of the 3-way solenoid valves according to the second embodiment may be connected to the accumulator, the second port 275_b may be connected to the wheel brakes w2, and the third port 275_c may be connected to the outlet of the pump 260. In the present disclosure, the three-way solenoid valve 270 connected in this way is referred to as a wheel-side integrated valve 270. The brake system 200 may include a front left wheel-side integrated valve 270a, a front right wheel-side integrated valve 270b, a rear left wheel-side integrated valve 270c, and a rear right wheel-side integrated valve 270d. The wheel-side integrated valve 270 functions as both the inlet valve and the outlet valve. Since the structure, operation mechanism, and function of the wheel-side integrated valve 270 according to the second embodiment are substantially the same as those of the 3-way solenoid valve 170 according to the first embodiment of the present disclosure, the redundant descriptions thereof will be omitted.

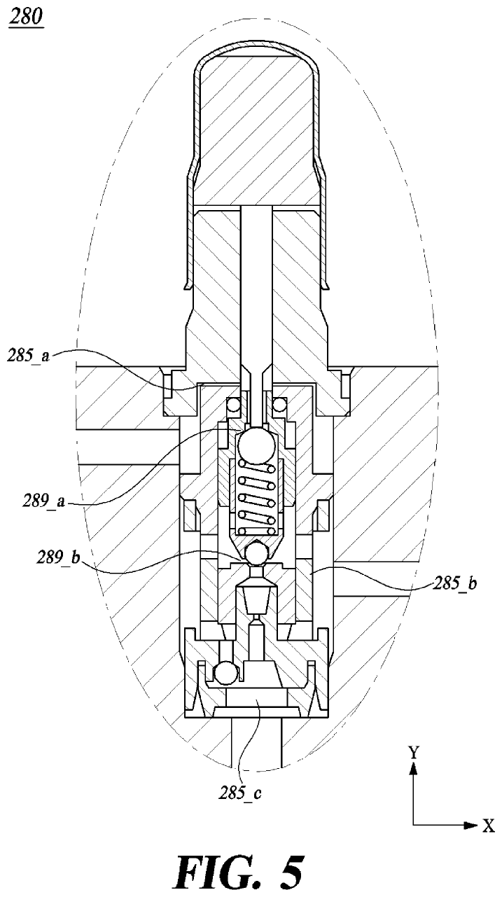

FIG. 5 is a cross-sectional view illustrating an integrated valve on the pressing unit side of the brake system 200 according to the second embodiment of the present disclosure.

Referring to FIG. 5, in at least a part of the 3-way solenoid valves according to the second embodiment of the present disclosure, a first port 285_a is connected to the inlet of the pump 260, a second port 285_b is connected to the master cylinder 250, and a third port 285_c is connected to the wheel brakes w2. Referring to FIGS. 2 and 5, in at least a part of the 3-way solenoid valves according to the second embodiment, the first port 285_a may be connected to the inlet of the pump 260, the second port 285_b may be connected to the master cylinder 250, and the third port 285_c may be connected to the wheel brakes w2. In the present disclosure, the three-way solenoid valve connected in the way is referred to as a pressing unit-side integrated valve 280. The brake system 200 may include a first pressing unit-side integrated valve 280 and a second pressing unit-side integrated valve 280. Referring to FIGS. 2 and 5, the master cylinder 250 is connected in series between the oil reservoir and the pressing unit-side integrated valve 280, and the pressing unit-side integrated valve 280 is connected to the master cylinder 250, the inlet of the pump 260, and the wheel brakes w2. The pressing unit-side integrated valve 280 functions as both a normal open type traction control valve and a normal close type high-pressure switch valve. The first pressing unit-side integrated valve 280 is connected to the first pump 260, the first hydraulic chamber, the front left wheel brake w2, and the rear right wheel brake w2 through the first to third ports 285_c. The second pressing unit-side integrated valve 280 is connected to the second pump 260, the second hydraulic chamber, the front right wheel brake w2, and the rear left wheel brake w2 through the first to third ports 285_c. A first opening/closing flow passage 289_a of the pressing unit-side integrated valve 280 is configured to fluid-communicate with or block the first port 285_a and the second port 285_b. The second opening/closing flow passage 289_b is configured to fluid-communicate with or block the second port 285_b and the third port 285_c. When the first opening/closing flow passage 289_a of the pressing unit-side integrated valve 280 is closed and the second opening/closing flow passage 289_b is opened, the fluid pressurized in the master cylinder 250 may be transferred to the wheel brakes w2, and the fluid on the oil reservoir side is not transferred to the inlet of the pump 260. Such a fluid flow path corresponds to a fluid flow path in the case that a traction control valve is opened and a high-pressure switch valve is closed in the conventional brake system for a vehicle. In addition to the difference in components connected to each port and the difference in functions, the structure and operation mechanism of the pressing unit-side integrated valve 280 are substantially the same as those of the 3-way solenoid valve 170 according to the first embodiment, and thus the redundant description thereof will be omitted. The brake system of the present disclosure is not limited to the configuration and arrangement of the brake systems 100 and 200 according to the first and second embodiments. For example, the brake system of the present disclosure may include at least one 3-way solenoid valve, the inlet valve, and the outlet valve.

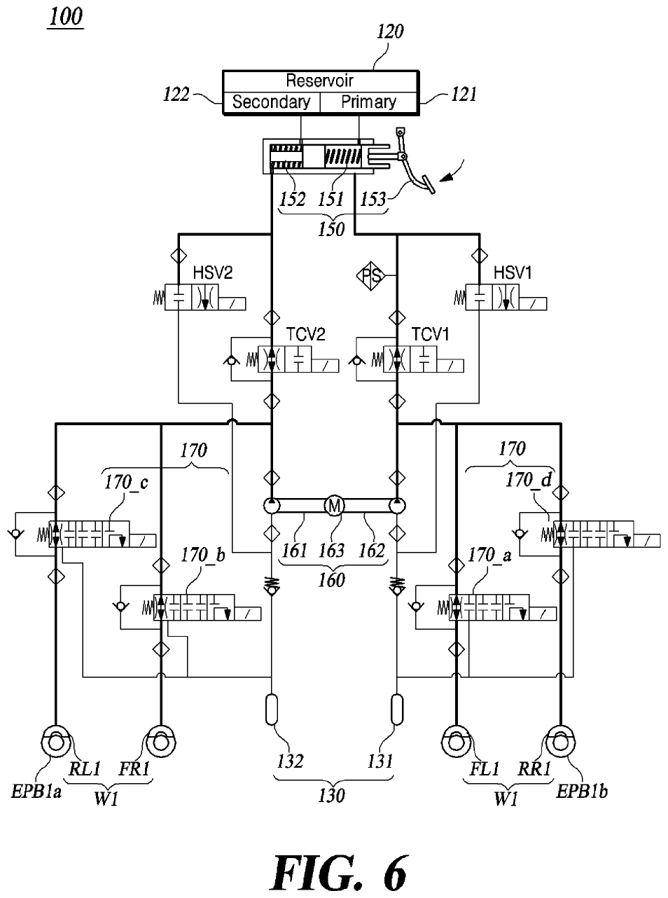

FIG. 6 is a hydraulic circuit diagram illustrating a flow path of the fluid in the case that braking pressure of the brake system for a vehicle according to the first embodiment of the present disclosure is increased.

Referring to FIG. 6, a driver presses the pedal 153. In the case that a required braking force corresponding to an input amount of the pedal 153 of the driver may be formed using the hydraulic pressure of the master cylinder 150, the pump 160 may not be driven. The high-pressure switch valves HSV1 and HSV2 are closed such that fluid is not transferred from the oil reservoir 120 to the inlet of the pump 160. The traction control valves TCV1 and TCV2 are opened such that the hydraulic pressure by the master cylinder 150 is transferred to the wheel brakes w1. The 3-way solenoid valve 170 closes the flow path connected from the wheel brakes w1 to the accumulator 130 and opens the flow path connected from the master cylinder 150 to the wheel brake w1. When the first electromagnetic force is applied to the 3-way solenoid valve 170 according to one embodiment of the present disclosure, the first opening/closing flow passage 179_a is closed and the second opening/closing flow passage 179_b is opened to guide the fluid through the route as shown in FIG. 6. As the hydraulic pressure formed in the master cylinder 150 is transferred to the wheel brakes w1, the hydraulic pressure in the wheel brakes w1 increases, which increases the braking force.

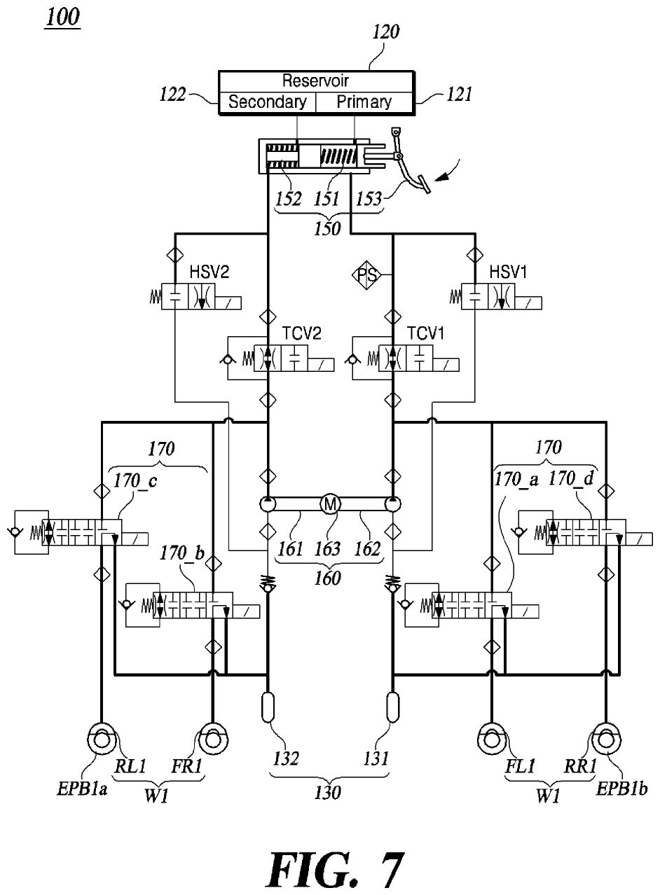

FIG. 7 is a hydraulic circuit diagram illustrating a flow path of the fluid in the case that braking pressure of the brake system for a vehicle according to the first embodiment of the present disclosure is reduced.

Referring to FIG. 7, a driver presses the pedal 153. In the case that ABS function is operated to prevent a wheel lock phenomenon or a system of an autonomous vehicle determines that the braking force of the brake system 100 is to be reduced, the brake system 100 may need to reduce the braking force even though the driver presses the pedal 153. In this case, the high-pressure switch valves HSV1 and HSV2 are closed such that the fluid is not transferred from the oil reservoir 120 to the inlet of the pump 160. The 3-way solenoid valve 170 closes the flow path connected from the fluid pressing units 150 and 160 to the wheel brakes w1, and opens the flow path connected from the wheel brakes w1 to the accumulator 130. In this way, the fluid in the wheel brakes w1 is transferred to the accumulator 130 and the braking force is reduced. When the third electromagnetic force is applied to the 3-way solenoid valve 170 according to one embodiment of the present disclosure, the first opening/closing flow passage 179_a is opened and the second opening/closing flow passage 179_b is closed, thereby guiding the fluid through the route as shown in FIG. 7.

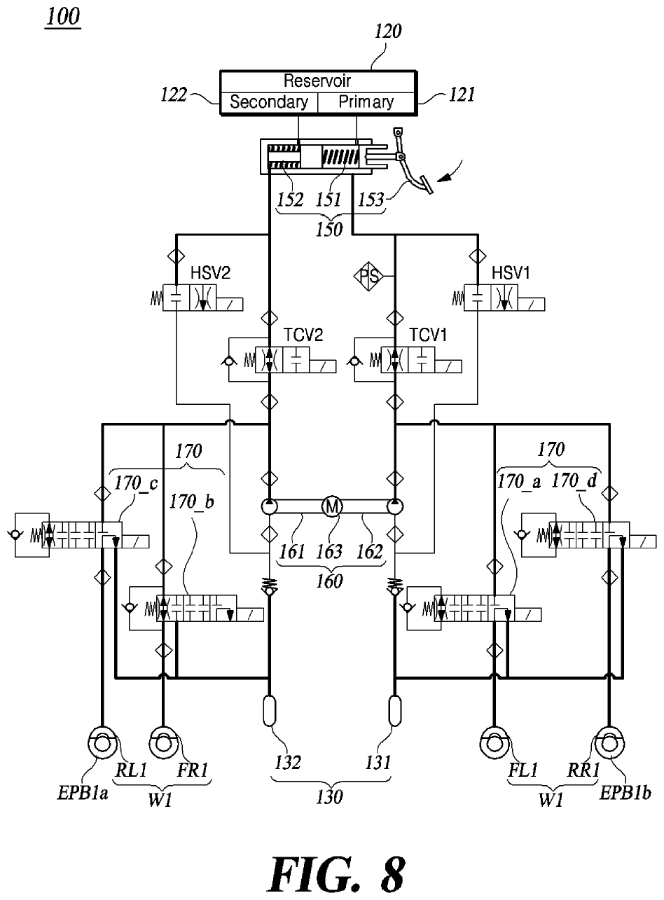

FIG. 8 is a hydraulic circuit diagram illustrating a flow path of the fluid in the case that hydraulic pressure is selectively supplied to a part of the wheel brakes according to the first embodiment of the present disclosure.

Referring to FIG. 8, a driver presses the pedal 153. Since the traction control valves TCV1 and TCV2 are opened, the fluid pressurized by the master cylinder 150 may be transferred to the front right wheel brake FR1. In order to increase only the braking force applied by the brake system 100 to the front right wheel, the first opening/closing flow passage 179_a of the front right wheel-side integrated valve 170b is closed and the second opening/closing flow passage 179_b is opened. In order to reduce the braking force applied by the brake system 100 to the front left wheel, the rear left wheel, and the rear right wheel, the first opening/closing flow passage 179_a of the front left, rear left and rear right wheel-side integrated valves 170_a, 170_b and 170_d is opened and the second opening/closing flow passage 179_b is closed. In the brake system 100 according to one embodiment of the present disclosure, the first current is applied to the front right wheel-side integrated valve 170_b, and the third current is applied to the front left, rear left, and rear right wheel-side integrated valves 170_a, 170_b, and 170_d, thereby guiding the fluid through the route as shown in FIG. 8.

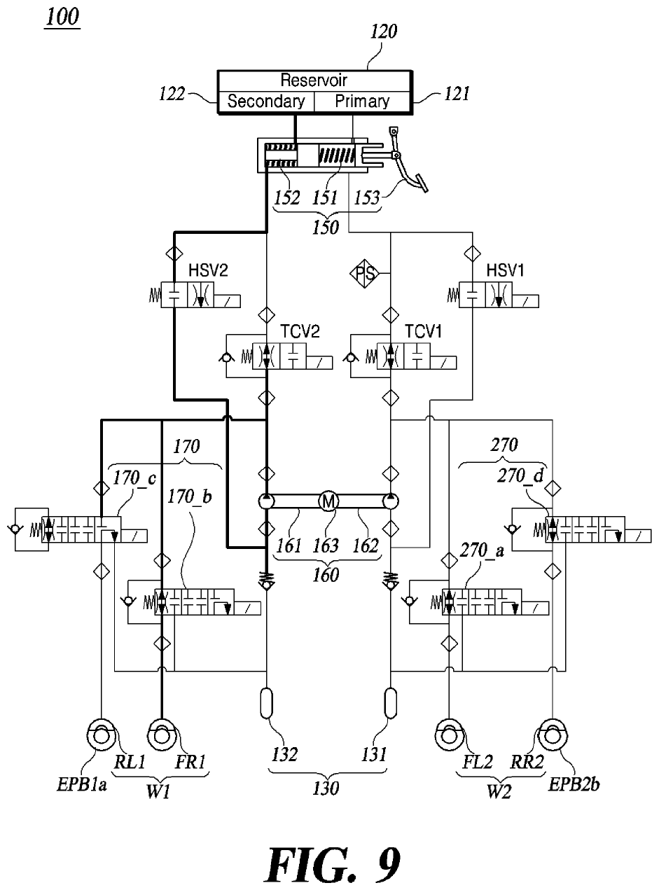

FIG. 9 is a hydraulic circuit diagram illustrating a flow path of the fluid in the case that the second pump of the brake system according to the first embodiment of the present disclosure is driven.

When a required braking force calculated using a braking signal is smaller than the braking force currently formed by the brake system 100, the pump 160 may pressurize the fluid. Referring to FIG. 9, the pedal 153 is not pressed. Since the first pump 161 is not driven, braking pressure applied to the front left wheel and the rear right wheel is maintained. The second high pressure switch valve HSV2 is opened. The fluid is transferred to the inlet of the second pump 161 through the second reservoir chamber 122, the second hydraulic chamber 152, and the second high pressure switch valve HSV2 sequentially. The first opening/closing flow passage 179_a of the front right wheel-side integrated valve 170b is closed, and the second opening/closing flow passage 179_b is opened. The fluid pressurized by the second pump 162 sequentially passes through the third port and the second port of the front right wheel-side integrated valve 170_b to be transferred to the front right wheel brake FR1. This increases the braking pressure applied to the front right wheel. The first opening/closing flow passage 179_a of the rear left wheel-side integrated valve 170_c is opened, and the second opening/closing flow passage 179_b is closed. Accordingly, the hydraulic pressure in the rear left wheel brake RL1 is reduced.

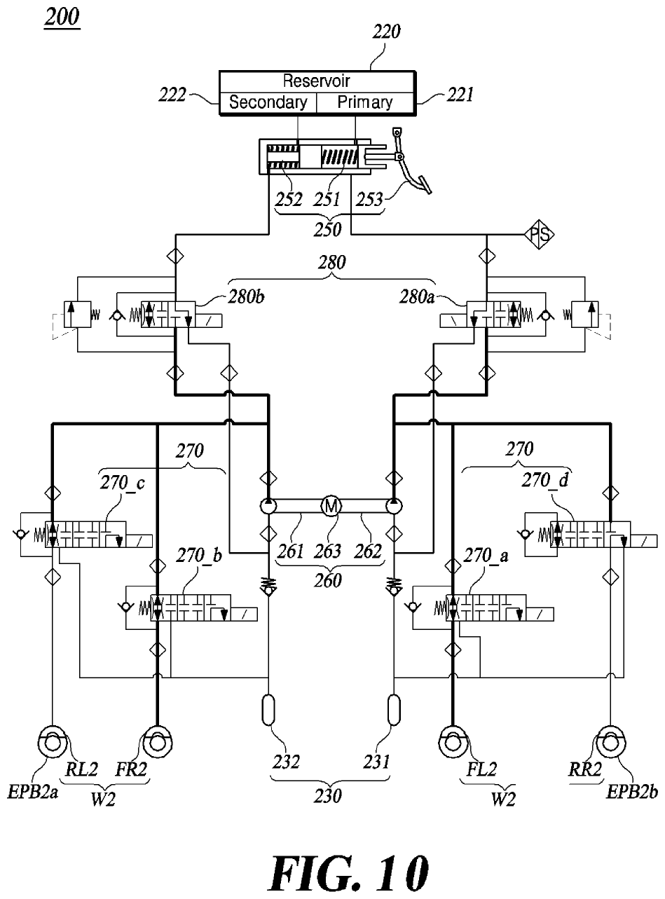

FIG. 10 is a hydraulic circuit diagram illustrating a flow path of the fluid in the case that the pump of the brake system according to the second embodiment of the present disclosure is driven.

Referring to FIG. 10, a driver does not press the pedal 253. The first and second pumps 261 and 262 are driven to increase the braking pressure applied to the front left wheel and the rear left wheel. The fluid on the side of the oil reservoir 220 sequentially passes through the master cylinder 250, the second port 285_b of the fluid pressing unit-side integrated valve 280, and the first port 285_a to be transferred to the inlet of the pump 260. The first opening/closing flow passage 279_a of the rear left and rear right wheel-side integrated valves 270_c and 270_d is opened, and the second opening/closing flow passage 279_b is closed. Accordingly, the fluid in the rear left wheel brake RL2 is transferred to the second accumulator 232 to reduce the braking pressure applied to the rear left wheel. The fluid in the rear right wheel brake RR2 is transferred to the first accumulator 231 to reduce the braking pressure applied to the rear right wheel. The first opening/closing flow passage 279_a of the front left and front right wheel-side integrated valves 270_a and 270_b is closed, and the second opening/closing flow passage 279_b is opened. Accordingly, the fluid pressurized by the first pump 261 is supplied to the front left wheel brake FL2, and the fluid pressurized by the second pump 262 is supplied to the front right wheel brake FR2, thereby increasing the braking pressure applied to the front wheels. Braking force may be applied to the rear wheels by using the electronic parking brake EPB2 mounted on each rear wheel.

According to one embodiment of the present disclosure, the brake system for the vehicle includes the 3-way solenoid valve so that the number of solenoid valves mounted to the brake system is reduced.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A brake system for a vehicle, comprising:
a fluid storage unit;
a fluid pressing unit;
a plurality of wheel brakes configured to apply a braking force to the vehicle; and
at least one 3-way solenoid valve configured to selectively interconnect the fluid storage unit, the fluid pressing unit and the plurality of wheel brakes,
wherein the at least one 3-way solenoid valve comprises:
first, second and third ports;
an armature to which an electromagnetic force is applied;
a first body having a first hollow and a portion facing the armature;
a second body having a second hollow and having a portion facing the first body;
a plunger having a portion extending into the first hollow of the first body and the second hollow of the second body, having a first end adjoining the armature, and configured to move when the first end is pressed by the armature;
a first opening/closing flow passage configured to selectively allow a fluid flow between the first port and the second port; and
a second opening/closing flow passage configured to selectively allow a fluid flow between the second port and the third port.

2. The brake system of claim 1, wherein the first port is connected to the fluid storage unit, the second port is connected to the wheel brakes, and the third port is connected to an outlet of the fluid pressing unit.

3. The brake system of claim 2, further comprising:
a traction control valve configured to control a flow path from a master cylinder to each of the wheel brakes; and
a high-pressure switch valve configured to control a flow path from an oil reservoir to an inlet of a pump,
wherein the fluid storage unit includes the oil reservoir, and the fluid pressing unit includes the master cylinder and the pump.

4. The brake system of claim 1, wherein:
the fluid pressing unit includes a master cylinder and a pump,
the master cylinder is connected to the fluid storage unit, and
the first port is connected to an inlet of the pump, the second port is connected to the master cylinder, and the third port is connected to the plurality of wheel brakes.

5. The brake system of claim 1, further comprising an electronic parking brake mounted on at least one of the plurality of wheels.

6. The brake system of claim 1, wherein a groove disposed at a lower end of the first body and an upper surface of the second body form an outer peripheral surface of a discharge flow path.

7. The brake system of claim 1, wherein a groove disposed at an upper end of the second body and a lower surface of the first body forms an outer peripheral surface of a discharge flow path.

8. The brake system of claim 1, wherein:
the first body has a lower surface at which a groove portion is disposed, and
the second body is at least partially accommodated in the groove portion.

9. The brake system of claim 1, wherein the first body has a lower end portion at which a flange portion is disposed.

10. The brake system of claim 1, wherein:
the first opening/closing flow passage is configured to be closed when a first electromagnetic force is applied to the armature, and
the second opening/closing flow passage is configured to be opened when the first electromagnetic force is applied to the armature.

11. The brake system of claim 10, wherein:
the first opening/closing flow passage is configured to be closed when a second electromagnetic force greater than the first electromagnetic force is applied to the armature, and
the second opening/closing flow passage is configured to be opened when the second electromagnetic force is applied to the armature.

12. The brake system of claim 11, wherein:
the first opening/closing flow passage is configured to be opened when a third electromagnetic force greater than the second electromagnetic force is applied to the armature, and
the second opening/closing flow passage is configured to be closed when the third electromagnetic force is applied to the armature.

13. The brake system of claim 1, wherein the second opening/closing flow passage is configured to be opened by hydraulic pressures at the second and third ports when no electromagnetic force is applied to the armature.

14. The brake system of claim 1, wherein the at least one 3-way solenoid valve is configured such that an amount of fluid flowing between the first, second and third ports changes in response to a change to the electromagnetic force applied to the armature.
